(19) United States
(12) Patent Application Publication
(10) Pub. No.: US 2025/0220144 A1
(43) Pub. Date: Jul. 3, 2025

(54) MULTI-FORMAT KEYING

(71) Applicant: Mo-Sys Engineering Limited, London (GB)

(72) Inventor: Michael Paul Alexander Geissler, London (GB)

(73) Assignee: Mo-Sys Engineering Limited, London, OT (GB)

(21) Appl. No.: 18/881,090

(22) PCT Filed: Jul. 3, 2023
(86) PCT No.: PCT/GB2023/051738

§ 371 Date: Jan. 3, 2025

(30) Foreign Application Priority Data
Jul. 4, 2022 (GB) 2209822.2

(51) Int. Cl. H04N 9/75; G06T 7/11; G06T 7/90; G06T 11/00; H04N 9/64

(52) U.S. Cl. CPC H04N 9/75; G06T 7/11; G06T 7/90; G06T 11/001; H04N 9/643; G06T 2207/10024; G06T 2207/20221

(57) ABSTRACT

A method for post processing video includes receiving an input video stream Luma keyed regions are detected in a portion of the video stream. Chroma keyed regions are detected in a portion of the video stream. The detected regions are replaced with regions from replacement imagery to form an output video stream.

This invention relates to capturing video and still images.

Sometimes there is a need to replace parts of a captured image so that they look different. For example, when a video of an actor has been captured in a studio, it may be desired to replace the studio as depicted in the video with an outdoor landscape or a fantasy scene.

One way to do this is by using chroma keying. With chroma keying, the subject, e.g. the actor, is videoed against a backdrop of a particular colour. Once the video has been captured, the video is postprocessed to replace regions of the particular colour with the desired replacement imagery. Typically the colour is green, but other colours can be used. One disadvantage of chroma keying is that the subject must not bear any regions of the particular colour; otherwise those regions in the subject might also be replaced during post processing.

An alternative to chroma keying is luma keying. With luma keying the backdrop is differentiated from the subject by luminance rather than colour. The subject can be shot against a dark background. If the subject is well illuminated then the subject can be expected to appear lighter than the background. Then in post-processing dark regions of the video can be replaced by the desired replacement imagery. One disadvantage of luma keying is that especially non-reflective materials, which might be expected to work best for luma key backdrops, have fine microstructure that is sensitive to mechanical damage.

Another option is to use a display wall behind the subject. The desired background is displayed on the display wall whilst the video is being captured. Then there may be no need to perform replacement in post processing. However, display walls are relatively expensive.

There is a need for an improved approach to capturing video with a desired background.

According to one aspect there is provided a method for post processing video comprising: receiving an input video stream; detecting in a portion of the video stream both luma keyed regions and chroma keyed regions; and replacing the detected regions with regions from replacement imagery to form an output video stream. The step of detecting luma keyed regions may comprise detecting spatial regions having a luminosity lower than a predetermined luminosity. The step of detecting chroma keyed regions may comprise detecting regions of a predetermined hue.

The method may comprise replacing in a single operation both luma keyed and chroma keyed regions. Thus, the method may comprise: forming a replacement region comprising both detected luma key regions and detected chroma key regions, and replacing the input video in the replacement region with the replacement imagery.

The replacement imagery may be still or video.

The input video stream may comprise a plurality of frames. The method may comprise, for each frame in succession: detecting in that frame both luma keyed regions and chroma keyed regions; and replacing in that frame the detected regions with regions from replacement imagery to form a frame of an output video stream

According to a further aspect there is provided a computer configured to perform the method set out above.

According to a further aspect there is provided a data store storing code executable by a processor to perform the method set out above.

According to a further aspect there is provided studio set comprising a floor and a wall behind and above the floor, the wall exposing an extended surface having a reflectance in the visible spectrum that is less than 10% and the floor exposing an extended surface of a uniform predetermined hue.

The floor may extend with a horizontal component. The surface of the predetermined hue may cover the whole or part of the floor. Other parts of the floor may optionally be covered by the surface having a relatively low reflectance.

The wall may extend with a vertical component. The surface having relatively low reflectance may cover all or part of the wall.

Each extended surface may have a contiguous area greater than 5 m².

The predetermined hue may be a blue or a green. The surface having relatively low reflectance may appear black.

According to a further aspect there is provided a method of capturing video or still images comprising directing a camera at a set as set out above with one or more subjects supported on the floor, the subjects being, collectively, in front of a part of the extended surfaces of the wall and the floor from the point of view of the camera.

The method may further comprise, subsequent to the directing step: post-processing video or images captured by the camera to (a) identify regions of relatively low luminance therein and replace them by regions of replacement imagery and (b) identify regions of the predetermined hue therein and replace them by regions of the replacement imagery.

According to a further aspect there is provided a method of post-processing a video comprising performing both luma key replacement and chroma key replacement on a frame of the video. Luma key replacement and chroma key replacement may both be performed on multiple frames of the video. The method may comprise receiving from a user an indication of a first spatial region of the video and a second spatial region of the video and preferentially performing luma key replacement in the first region and preferentially performing chroma key replacement in the second region.

The post processing may be performed by a computer.

The post processing may be performed in real time. That is to say, immediately the input video is captured, e.g. within a second of the input video being captured.

The present invention will now be described by way of example with reference to the accompanying drawings. In the drawings:

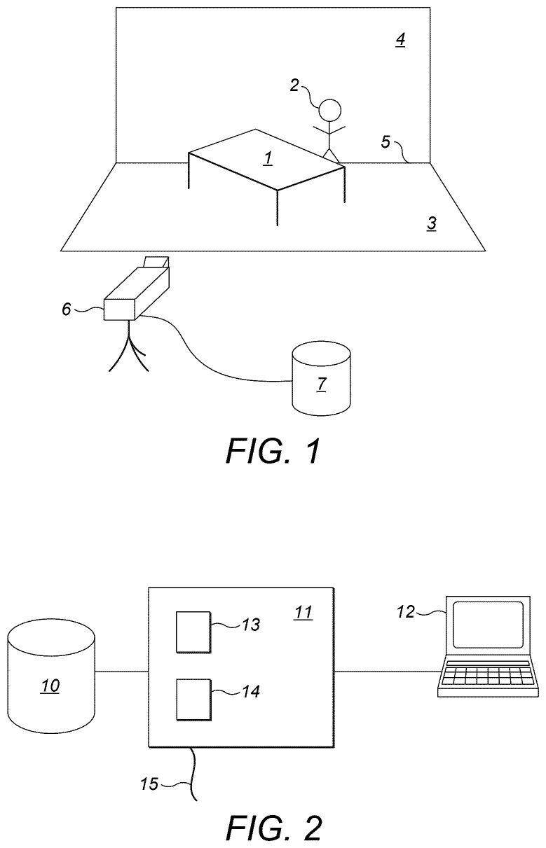

FIG. 1 shows a video set.

FIG. 2 shows a post-processing suite.

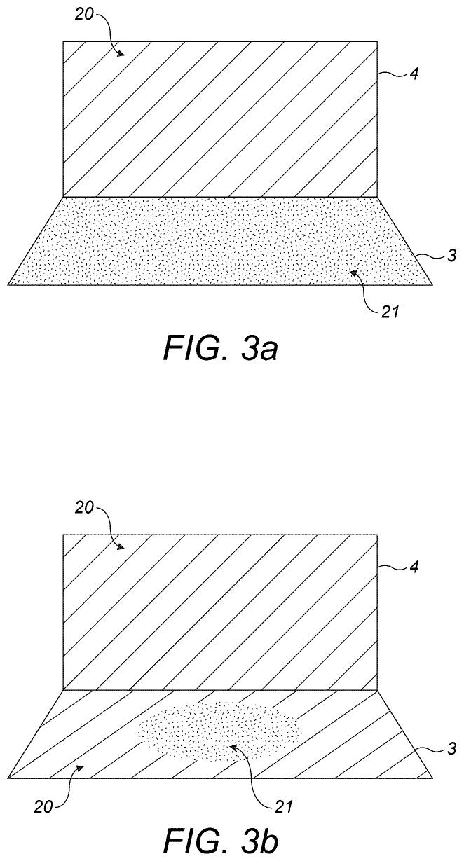

FIG. 3 shows examples of layouts for multi-key backgrounds.

FIG. 1 shows a set for capturing video or still images. It may be a movie set, a TV studio, a photography studio or any other suitable environment. The examples to be discussed below will be described with reverence to video capture, but the principles can equally be applied to still photography or to individual frames of captured video.

Subjects 1, 2 are located on the set. In this example subject 1 is a table and subject 2 is an actor. The subjects could be any suitable animate or inanimate objects. Typically, the subjects will be intended to appear in the foreground of the final output video. The subjects are supported on a floor 3. The floor may be flat or uneven. The floor will extend with a horizontal component but it need not be truly horizontal. A wall 4 extends upwards behind the subjects. The wall may be flat or uneven. In the example of FIG. 1 it is curved about a vertical axis with the concave side of the wall facing the subjects. The wall will extend with a vertical component but it need not be truly vertical. The wall may abut the floor as shown at 5, or there may be a gap between the two.

A camera 6 is provided for capturing video of the subjects against the backdrop provided by the floor 3 and the wall 4. Video captured by the camera is stored in data store 7.

FIG. 2 shows a post-processing suite for performing post processing on video. The post-processing suite comprises a data store 10. In practice that might be the same as data store 7. It also comprises a post-processing computer (PPC) 11 and a user terminal 12. The computer comprises a processor 13 and a memory 14. The memory stores in non-transient form code executable by the processor 13. When the processor implements that code it makes the PPC 11 provide the functions described of it herein.

The PPC is capable of performing chroma keying and luma keying. To perform chroma keying, the PPC processes an input video stream stored in store 10 to replace certain parts of that video stream. The resulting output video stream with the replaced parts is stored in store 10 or output via data link 15 as an output video stream. The parts to be replaced are determined as follows. A user of terminal 12 can designate a chroma key colour. Alternatively, the PPC may select a default chroma key colour, for instance green. The user can designate a segment that is a time-limited subset of the input video stream, for instance a segment from one minute to two minutes from the start of the stream. Alternatively, the PPC may select a default segment, for instance the whole of the input video stream. The user may designate a positional region in the video to which the chroma key post-processing is to be limited, or the chroma key post-processing may be performed on the entire area of the video. Furthermore, the user may designate still or video content that is to be used to replace parts of the video stream. That replacement content may be previously-captured video or computer-generated imagery (CGI). The user may designate a transformation between the replacement content and the input video stream. That transformation may fix any one or more of registration offset, relative orientation, colour shifts, brightness shifts and spatial warping between the replacement content and the input video. The aim of such transformations is typically to adapt the replacement content to visually match the input video stream. The PPC processes the designated segment(s) and region(s) of the input stream to detect places where the chroma key colour appears. It replaces those with selected parts of the replacement content to form the output video stream.

To perform luma keying, the PPC processes the input video stream stored in store 10 to replace certain parts of that video stream. The resulting output video stream with the replaced parts is stored in store 10 or output via data link 15 as an output video stream. The parts to be replaced are determined as follows. A user of terminal 12 can designate a luma key threshold luminance. Alternatively, the PPC may select a default luma key threshold luminance. The user can designate a segment that is a time-limited subset of the input video stream, for instance a segment from one minute to two minutes from the start of the stream. Alternatively, the PPC may select a default segment, for instance the whole of the input video stream. The user may designate a positional region in the video to which the luma key post-processing is to be limited, or the luma key post-processing may be performed on the entire area of the video. Furthermore, the user may designate still or video content that is to be used to replace parts of the video stream. That replacement content may be previously-captured video or computer-generated imagery (CGI). The user may designate a transformation between the replacement content and the input video stream. That transformation may fix any one or more of registration offset, relative orientation, colour shifts, brightness shifts and spatial warping between the replacement content and the input video. The aim of such transformations is typically to adapt the replacement content to visually match the input video stream. The PPC processes the designated segment(s) and region(s) of the input stream to detect places where the luminance is less than the threshold luminance. It replaces those with selected parts of the replacement content to form the output video stream.

The PPC may apply a threshold around the designated chroma key hue to increase the likelihood that all chroma keyed regions are successfully detected.

The PPC is capable of performing chroma keying and luma keying on the same input video. Typically, this will involve performing both types of keying on the same temporal segment of input video. The spatial regions of that video on which post-processing is performed may be the same, or alternatively different spatial parts of the input video may be designated for chroma key post processing and luma key post processing.

In the present system, backdrops for different types of keying are used for floor 3 and wall 4. In one arrangement, floor 3 carries a chroma key backdrop and wall 4 carries a luma key backdrop.

A chroma key backdrop may be a backdrop of a uniform colour. Most commonly that colour is green or blue but it could be another colour. Preferably it is a colour that has a hue such that it is not black, white or a grey. That makes it easier to avoid the chroma key colour being present in the subjects. The chroma key backdrop may be achieved by using a carpet or mat of the chroma key colour or by painting the underlying surface in the chroma key colour. Chroma key blue and green paints are commercially available.

A luma key backdrop may be a backdrop having a relatively low reflectance. For example, it may have a reflectance below 10% or more preferably below 8% or more preferably below 5% or more preferably below 2% or more preferably below 1% or more preferably below 0.5% or more preferably below 0.1% or more preferably below 0.01%. Such a backdrop will typically appear black to a viewer. Such a black may be provided by a fabric of sufficiently low reflectivity or by painting the underlying surface with a suitable paint. That may be an ordinary black paint or a paint specifically adapted to have especially low reflectance, for example by the incorporation of surface-modifying particles. The backdrop may be provided by a pre-fabricated sheet of low reflectance. Examples of materials having especially low reflectance are disclosed in “Breakdown of Native Oxide Enables Multifunctional, Free-Form Carbon Nanotube-Metal Hierarchical Architectures” (Cui and Wardle), ACS Appl. Mater. Interfaces 2019, 11, 38, 35212-35220 and EP 3 676 022.

In a simple arrangement, the chroma key backdrop may be used for the entirety of the floor and the luma key backdrop for the entirety of the wall behind the subject, at least within the field of view of the camera 6. In another arrangement, the chroma key backdrop may be used only in those locations of the floor on which the subject(s) is/are to be supported, and the luma key backdrop may be used elsewhere. FIG. 3 shows examples. In FIG. 3a the luma key backdrop 20 (cross-hatched) is applied to the entirety of the set wall 4 and to none of the set floor 3; and the chroma key backdrop 21 (dotted) is applied to the entirety of the set floor 3 and none of the set wall 4. In FIG. 3b the luma key backdrop 20 is applied to the entirety of the set wall 4 and also to part of the set floor 3; and the chroma key backdrop 21 is applied to only part of the set floor 3. Conveniently, in the arrangement of FIG. 3b, the region of the floor to which the chroma key backdrop is applied is laterally central with respect to the set. Conveniently it includes a portion of the floor adjacent the wall.

The floor and wall may merge into each other with a curved interface rather than with an abrupt angle. The boundary between the floor and the wall may be considered to be where the angle of the camera-facing surface to vertical is above/below 45 degrees.

When video is captured against a background as described above, the PPC can perform chroma keying over some parts of the captured video and luma keying over others. The PPC may automatically detect the luma key background through its low luminance and the chroma key background through its hue. To assist the accuracy of detection, a user of terminal 12 may designate those spatial regions of the video that incorporate the luma keyed and chroma keyed backgrounds.

The arrangement described above can provide several advantages.

First, ultra-black materials may have a sensitive surface microstructure that can readily be disrupted by mechanical contact or abrasion. Even regular black paint can readily be scuffed, making it appear shinier. By avoiding the use of luma keyed materials on the floor, or at least the part of the floor that will support the subjects, the likelihood of damage to the luma keyed backdrop can be reduced. By maintaining chroma keying on the remaining regions, keying of one sort or the other can still be carried out over the whole video frame.

Furthermore, the arrangement described above can take advantage of the visual considerations affecting upper and lower portions of a video typically being different. In the upper region of a video, typically above waist height or for instance 1 m above the ground, the presence of shadows is generally less important to the feeling of realism, whereas in that upper region actors' faces and light clothing are often present. When a chroma key background is used in that region there is potential for reflections from the chroma key background, arising for instance from strong studio lights as are commonly used, to cast unwanted tints on actors' faces and clothing. This is generally less of an issue in the lower region of the video frame because faces and to a lesser extent light clothing are less prevalent there. By using a relatively non-reflective background and/or a background of a neutral hue (black/grey) in the backdrop of the upper region such reflective effects can be reduced. Furthermore, some objects that are more typically found in the upper region of a video can be better discriminated for keying purposes against a luma key background than against a chroma key background. One example is thin strands of blond hair. On the other hand, in the lower parts of a video it is typically desirable to have shadows to improve a feeling of depth and to give a feeling of illumination from above. When a chroma key background is used for the floor, the subject(s) can case shadows on the floor, changing the luminance of the chroma key colour as detected by the PPC. When replacing with the replacement imagery the PPC can automatically apply shadow effects in the areas of lower luminance. In addition, since a chroma key colour is typically a bright colour, it is generally less likely that such a colour will be present in objects lower in a scene than higher in the scene. Lower-positioned objects are typically items such as trousers, shoes or chairs, which are frequently in subdued colours. Thus the possibility that the chroma key colour will appear in a foreground object may be less lower in a scene.

The studio set may be indoors. It may be equipped with filming equipment such as any of one or more cameras, one or more lights, one or more video prompts, one or more diffusers.

The region of relatively low reflectance may be of low reflectance relative to the chroma key region and/or relative to an absolute reference such as 10%. The reflectance may be measured as a mean across the visible spectrum. The visible spectrum may be considered to consist of wavelengths from 380 to 700 nm.

The region of relatively low reflectance may be a region having a substantial extent over the wall. It may thus be an extended surface. It may have a contiguous extent of more than 5 m² or 10 m².

The chroma key region may be a region having a substantial extent over the floor. It may thus be an extended surface. It may have a contiguous extent of more than 5 m² or 10 m². The chroma key region may be blue, for example corresponding to a wavelength in the range from 450 to 495 nm. The chroma key region may be green, for example corresponding to a wavelength in the range from 495 to 570 nm.

When video has been captured against the diverse backgrounds as described above, it can be passed to the PPC for post processing. The video may be composed of frames. Each frame represents a portion of the video stream at a single time. The PPC performs replacement based on both chroma keying and luma keying in a single pass through the video. Its output is an output video in which the luma keyed regions (of relatively low luminance) and chroma keyed regions (of a predetermined hue) have both been replaced. The PPC may be configured to operate on the input video frame by frame. In each frame it may determine regions that match predetermined criteria for luma keyed regions or that meet predetermined criteria for chroma keyed regions and may then replace those regions with the corresponding part of the replacement video. The PPC may then move to process the next frame. In this way, the PPC can conveniently process the input video in real time. By identifying chroma keyed and luma keyed regions of the video a single replacement operation can be performed. That can result in quicker processing and better matching between the replacement regions than if two separate replacement steps were to be performed.

The post processing as described above may be performed immediately after the input video has been captured. The post processing may be performed on a portion of the captured/input video immediately it is captured, whilst further video in the same stream is being captured.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

The phrase “configured to” or “arranged to” followed by a term defining a condition or function is used herein to indicate that the object of the phrase is in a state in which it has that condition, or is able to perform that function, without that object being modified or further configured.

1. A method for post processing video comprising:
receiving an input video stream;
detecting in a portion of the video stream both luma keyed regions and chroma keyed regions; and
replacing the detected regions with regions from replacement imagery to form an output video stream.

2. A method as claimed in claim 1, comprising replacing in a single operation both luma keyed and chroma keyed regions.

3. A method as claimed in claim 1, wherein the input video stream comprises a plurality of frames, and the method comprises, for each frame in succession:
detecting in that frame both luma keyed regions and chroma keyed regions; and
replacing in that frame the detected regions with regions from replacement imagery to form a frame of an output video stream.

4. A studio set comprising a floor and a wall behind and above the floor, the wall exposing an extended surface having a reflectance in the visible spectrum that is less than 10% and the floor exposing an extended surface of a uniform predetermined hue.

5. A studio set as claimed in claim 4, wherein the floor extends with a horizontal component.

6. A studio set as claimed in claim 4, wherein the wall extends with a vertical component.

7. A studio set as claimed in claim 4, wherein each extended surface has a contiguous area greater than 5 m².

8. A studio set as claimed in claim 4, wherein the predetermined hue is a blue or a green.

9. A method of capturing video or still images comprising directing a camera at a studio set comprising a floor and a wall behind and above the floor, the wall exposing an extended surface having a reflectance in the visible spectrum that is less than 10% and the floor exposing an extended surface of a uniform predetermined hue with one or more subjects supported on the floor, the subjects being, collectively, in front of a part of the extended surfaces of the wall and the floor from the point of view of the camera.

10. A method of capturing video or still images as claimed in claim 9, comprising, subsequent to the directing step:
post-processing video or images captured by the camera to (a) identify regions of relatively low luminance therein and replace them by regions of replacement imagery and (b) identify regions of the predetermined hue therein and replace them by regions of the replacement imagery.

11. The studio set as claimed in claim 5, wherein the wall extends with a vertical component.

12. The studio set as claimed in claim 5, wherein each extended surface has a contiguous area greater than 5 m².
